(19) United States
(12) Patent Application Publication
(10) Pub. No.: US 2024/0158094 A1
(43) Pub. Date: May 16, 2024

(54) ADDITIVE MANUFACTURED FUEL TANKS

(71) Applicant: RapidFlight Holdings LLC, Manassas, VA (US)

(72) Inventor: Robert J. Searle, Chicago, IL (US)

(21) Appl. No.: 18/098,923

(22) Filed: Jan. 19, 2023

Related U.S. Application Data
(60) Provisional application No. 63/424,301, filed on Nov. 10, 2022.

(51) Int. Cl. B64D 37/04; B33Y 80/00; B64D 37/06; B64F 5/10; F28D 1/06

(52) U.S. Cl. CPC B64D 37/04; B33Y 80/00; B64D 37/06; B64F 5/10; F28D 1/06; B33Y 10/00; F24H 2250/02

(57) ABSTRACT

In one example of the present disclosure, a fuel system for an aircraft, with the fuel system being made by an additive manufacturing process, is provided. The fuel system can include a fuel tank having a body defining an inner chamber configured to store fuel. The fuel system can also include a conduit formed monolithically with the body during the additive manufacturing process. The conduit can extend within the inner chamber and define a channel that is not in fluid communication with the inner chamber.

### FIELD

The present disclosure generally pertains to a system for a vehicle. More specifically, the present disclosure pertains to a fuel system having an additive manufactured fuel tank for a vehicle, such as an aircraft.

### BACKGROUND

Additive manufacturing is a manufacturing process that sequentially adds or “prints” thin layers of material on top of each other to form an object. Additive manufacturing of an object, including a part for a structure, is desirable as it provides the ability to rapidly change out parts and keep the stock of parts low. However, the current technology does not provide for assembling a structure from several components without loss in one or more of the mechanical properties of the structure. Moreover, the current technology presents difficulties in additive manufacturing of a structure that includes unsupported middle or end portions. Additionally, additive manufactured parts can introduce several drawbacks when utilized in specific industries.

### SUMMARY

This summary is provided to introduce a selection of concepts in a simplified form that are further described below in the detailed description. This summary is not intended to identify key features of the claimed subject matter, nor is it intended to be used as an aid in determining the scope of the claimed subject matter.

In accordance with one embodiment of the present disclosure, a fuel system for an aircraft, with the fuel system being made by an additive manufacturing process, is provided. The fuel system can include: a fuel tank having a body defining an inner chamber configured to store fuel; and a conduit formed monolithically with the body during the additive manufacturing process, the conduit extending within the inner chamber, wherein the conduit defines a channel that is not in fluid communication with the inner chamber.

In accordance with another embodiment of the present disclosure a method of manufacturing a fuel system for an aircraft is provided. The method can include: printing, using an additive manufacturing process, a body of a fuel tank, the body of the fuel tank defining an inner chamber configured to store fuel; and during printing of the body of the fuel tank, printing, using the additive manufacturing process, a conduit that is monolithic with the body of the fuel tank, wherein the conduit defines a channel that is not in fluid communication with the inner chamber.

In accordance with another embodiment of the present disclosure an aircraft assembly is provided. The aircraft assembly can include: an aircraft body component including a body coupling portion; and a fuel tank configured to be disposed within the aircraft body component, the fuel tank having a body including an inner chamber that is configured to hold fuel, wherein the fuel tank includes at least a first fuel tank coupling portion formed monolithically with the body adjacent to an exterior surface of the body, and wherein the at least first fuel tank coupling portion of the fuel tank is configured to be slidably received within the body coupling portion of the aircraft body component.

In any of the embodiments described herein, the body can include opposing first and second walls, and the conduit can extend within the inner chamber from the first wall to the second wall.

In any of the embodiments described herein, the body can include non-opposing first and third walls, and the conduit can extend within the inner chamber from the first wall to the third wall.

In any of the embodiments described herein, the fuel system can further comprise a heat exchanger system coupled to the body of the fuel tank, and the conduit can form at least a portion of the heat exchanger system.

In any of the embodiments described herein, the heat exchanger system can fluidly couple with the channel, and the conduit can be configured to enable heat exchange between fuel stored in the inner chamber and a fluid routed through the channel by the heat exchanger system.

In any of the embodiments described herein, the heat exchanger system can include a heating element, and the heating element can be routed through the conduit.

In any of the embodiments described herein, the fuel system can further include a reinforcing member formed monolithically with the body during the additive manufacturing process, wherein at least a portion of the reinforcing member can be a baffle extending into the inner chamber of the body of the fuel tank.

In any of the embodiments described herein, at least a second portion of the reinforcing member can be a rib extending outwards from an outer surface of the body of the fuel tank, wherein the rib can be aligned with the baffle.

In any of the embodiments described herein, the fuel tank can further include a second channel defined adjacent to an external surface of the body, and the second channel can be configured to receive a reinforcing rod therethrough.

In any of the embodiments described herein, the channel can be sized to receive an electrical wire therethrough, and the conduit can be configured to isolate the electrical wire from fuel stored in the inner chamber of the body.

In any of the embodiments described herein, the body can define a port extending from outside the body into fluid communication with the inner chamber, and the fuel tank can further include a fitting monolithically formed on the body during the additive manufacturing process, the fitting being configured to couple a hose in fluid communication with the inner chamber via the port.

In any of the embodiments described herein, the additive manufacturing process can include a plurality of layer deposition steps; printing the body can include depositing a plurality of body layers; printing the conduit can include depositing a plurality of conduit layers; and the method for manufacturing a fuel system for an aircraft can further comprise depositing at least one of the conduit layers in a layer deposition step of the additive manufacturing process that does not include depositing any of the plurality of body layers.

In any of the embodiments described herein, printing the body can include defining a port extending from outside the body into fluid communication with the inner chamber; and the method for manufacturing a fuel system for an aircraft can further comprise printing a fitting monolithic with the body during the additive manufacturing process, the fitting being configured to couple a hose in fluid communication with the inner chamber via the port.

In any of the embodiments described herein, the port can be defined on a first end portion of the body.

In any of the embodiments described herein, the method for manufacturing a fuel system for an aircraft can further include coupling a heat exchanger system to the body of the fuel tank, wherein the conduit can form at least a portion of the heat exchanger system.

In any of the embodiments described herein, coupling the heat exchanger system to the body can include fluidly coupling the heat exchanger system to the channel, and wherein the conduit can be configured to enable heat exchange between fuel stored in the inner chamber and a fluid routed through the channel by the heat exchanger system.

In any of the embodiments described herein, the method for manufacturing a fuel system for an aircraft can further include routing a heating element of the heat exchanger system through the conduit.

In any of the embodiments described herein, the method for manufacturing a fuel system for an aircraft can further include printing, during the additive manufacturing process, a reinforcing member monolithic with the body, wherein at least a portion of the reinforcing member can form a baffle within the inner chamber of the body.

In any of the embodiments described herein, printing the reinforcing member can further include printing a rib that extends outwards from an outer surface of the body of the fuel tank, wherein the rib can be aligned with the baffle.

In any of the embodiments described herein, the method for manufacturing a fuel system for an aircraft can further include installing the fuel tank within a fuselage of the aircraft.

In any of the embodiments described herein, the method for manufacturing a fuel system for an aircraft can further include installing the fuel tank within a wing of the aircraft.

In any of the embodiments described herein, the method for manufacturing a fuel system for an aircraft can further comprise fluidly coupling the inner chamber of the fuel tank to a fuel line of the aircraft such that the inner chamber of the fuel tank is in fluid communication with the fuel line of the aircraft.

In any of the embodiments described herein, the aircraft body component can be a wing of the aircraft assembly.

In any of the embodiments described herein, the fuel tank can further include a second fuel tank coupling portion formed adjacent to the exterior surface of the body, and the wing can include: a first wing portion having a first surface forming a leading edge of the wing assembly and a second surface, wherein the second surface of the first wing portion is configured to interlock with the first fuel tank coupling portion of the body when the fuel tank is slidably received within the wing; and a second wing portion having a first surface forming a trailing edge of the wing assembly and a second surface, wherein the second surface of the second wing portion is configured to interlock with the second fuel tank coupling portion of the body when the fuel tank is slidably received within the wing.

In any of the embodiments described herein, the aircraft body component can be a fuselage of the aircraft.

In any of the embodiments described herein, the aircraft assembly can further include a heat exchanger system coupled to the fuel tank.

In any of the embodiments described herein, the aircraft assembly can further include a conduit formed monolithically with the body of the fuel tank during the additive manufacturing process. The conduit can extend within the inner chamber, and the conduit can define a channel that is not in fluid communication with the inner chamber. The heat exchanger system can be fluidly coupled with the channel, and the conduit can be configured to enable heat exchange between fuel stored in the inner chamber and a fluid routed through the channel by the heat exchanger system.

In any of the embodiments described herein, the fuel tank can further include a conduit that extends at least from a first portion of the body to a second portion of the body.

In any of the embodiments described herein, the conduit can be monolithic with the body of the fuel tank.

In any of the embodiments described herein, the conduit can extend within the inner chamber of the body and is not fluidly coupled to the inner chamber of the body.

In any of the embodiments described herein, the conduit can extend adjacent to an exterior surface of the body and can be configured to receive a reinforcing rod therethrough.

In any of the embodiments described herein, the fuel tank can be a first fuel tank, the aircraft assembly can further include a second fuel tank disposed within the aircraft body component.

In any of the embodiments described herein, the second fuel tank can be slidably coupled to the first fuel tank.

In any of the embodiments described herein, the aircraft assembly can further include a second aircraft body component, wherein the fuel tank can be a first fuel tank, and the aircraft assembly can further include a second fuel tank disposed within the second aircraft body component.

In any of the embodiments described herein, the first aircraft body component can be a wing component and the second aircraft component can be a fuselage component, and the aircraft assembly can further include a connection bracket coupling the second fuel tank to the first fuel tank.

In any of the embodiments described herein, the aircraft assembly can further include a first plurality of reinforcing rods coupling the first fuel tank to the connection bracket and a second plurality of reinforcing rods coupling the second fuel tank to the connection bracket, wherein the second plurality of reinforcing rods are oriented transversely to the first plurality of reinforcing rods.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative examples, in which the principles of the disclosure are utilized, and the accompanying drawings of which:

FIG. 1 illustrates a perspective view of an aircraft assembly in accordance with one or more embodiments of the present disclosure.

FIG. 2 illustrates a perspective view of the aircraft assembly of FIG. 1 with a fuel system.

FIGS. 3A-3C illustrate various views of a fuel system positioned within an aircraft assembly in accordance with one or more embodiments of the present disclosure.

FIG. 4 illustrates a perspective view of an additive manufactured aircraft assembly in accordance with one or more embodiments of the present disclosure.

FIG. 5 illustrates a schematic view of a fuel system in accordance with one or more embodiments of the present disclosure.

FIG. 6 illustrates a perspective view of a fuel tank in accordance with one or more embodiments of the present disclosure.

FIG. 7 illustrates an internal view of the fuel tank of FIG. 6.

FIG. 8 illustrates a cross-sectional view of a fuel tank in accordance with one or more embodiments of the present disclosure.

FIG. 9A illustrates a perspective view of a fuel system in accordance with one or more embodiments of the present disclosure.

FIG. 9B illustrates a perspective view of the fuel system from FIG. 9A installed within an example wing of an aircraft assembly in accordance with one or more embodiments of the present disclosure.

FIG. 9C illustrates a perspective view of the fuel system from FIG. 9A installed within another example wing of an aircraft assembly in accordance with one or more embodiments of the present disclosure.

FIG. 10A illustrates a perspective view of several fuel tanks coupled together in accordance with one or more embodiments of the present disclosure.

FIG. 10B illustrates the fuel tanks from FIG. 10A installed within a wing of an aircraft assembly in accordance with one or more embodiments of the present disclosure.

FIG. 11 illustrates a perspective view of a fuel system installed within a fuselage of an aircraft assembly in accordance with one or more embodiments of the present disclosure.

FIG. 12 illustrates a perspective exploded view of a connection bracket in accordance with one or more embodiments of the present disclosure.

FIG. 13 illustrates a perspective partial exploded view of a fuel system installed in the wings and fuselage of an aircraft in accordance with one or more embodiments of the present disclosure.

FIG. 14. illustrates a perspective view of several fuel tanks coupled together in accordance with one or more embodiments of the present disclosure.

FIG. 15 is a flow diagram illustrating an example method for manufacturing a fuel tank in accordance with one or more embodiments of the present disclosure.

FIG. 16 is a flow diagram illustrating an example method for manufacturing a fuel system for an aircraft in accordance with one or more embodiments of the present disclosure.

### DETAILED DESCRIPTION

Utilizing additive manufacturing techniques to manufacture parts for an assembly can have several advantages over conventional manufacturing techniques. Additive manufacturing, for example, allows for more complex designs of a part, minimizes waste, and can lead to faster production times over conventional manufacturing techniques. These advantages can be realized in several industries. For example, a craftsperson can utilize additive manufacturing techniques to manufacture parts for an aircraft. In some situations, the frame, wings, fuselage, payload bays, booms, rotor blades, propellers, landing gear, control surfaces, and other aircraft components can be formed and assembled together using additive manufacturing techniques.

In some applications, parts manufactured using additive techniques can have less desirable mechanical properties when compared to parts manufactured through other techniques. There can be other challenges that arise that are specific to manufacturing particular components of a vehicle, such as an aircraft, as well. For example, a fuel tank can be difficult to integrate properly with a vehicle's structure and other systems.

The present disclosure addresses these problems with respect to fuel tanks for vehicles, and in particular, fuel tanks for aircraft. As described in further detail herein, additive manufactured fuel tanks of the present disclosure can be formed to simplify routing paths for avionics wiring through the fuel tank area, or to simplify connectivity with on-board heat exchanger systems. These heat exchanger systems may use the fuel in the fuel tank to cool other systems or fluids, such as a hydraulic fluid (e.g., used in hydraulic systems that position aircraft control surfaces). In certain embodiments, the heat exchanger systems may use the hydraulic fluid, some other heat transfer fluid, or an electrical heating element to warm fuel in the tank (e.g., on high-altitude flight paths that expose the fuel tank to freezing temperatures). In some embodiments, the fuel tank can be formed as a monolithic structure, which reduces a number of seams or component interfaces that must be sealed to prevent fuel leaks. In other embodiments, the fuel tank can be formed by multiple parts in a manner that seals to prevent fuel leaks. Furthermore, in certain embodiments, the fuel tank can be formed in a manner that allows for the fuel tank to integrate easily with the aircraft. For example, the fuel tank can include structures formed along the outer perimeter of the fuel tank that can interlock with other components of the aircraft, such as the wings or fuselage. Integrating the fuel tank with the aircraft in this manner allows for the aircraft to have a more compact design and allows for other advantages with the overall aircraft design. For example, the interlocking structures can provide additional structural integrity to the aircraft.

The present disclosure can also address issues with conventional fuel tanks through the present fuel tank's unique design. In some examples, the fuel tank can include conduits that define channels extending through, but isolated from fluid communication with, a fuel-holding chamber of the fuel tank. These conduits can be directly and integrally formed during the additive manufacturing process, allowing for the fuel tank to maintain its monolithic structure. In some examples, one or more of the conduits can be configured as a path for a heat transfer fluid or a heating element, enabling the as-manufactured fuel tank to be immediately coupled to a heat exchanger system of the aircraft, and reducing or eliminating additional steps for sealing the heat exchanger system from the fuel. Additionally, or alternatively, in certain examples, one or more of the conduits can be configured as passthrough lines for electrical wiring, enabling the size of the fuel tank to be increased while still accommodating isolated electrical pathways for avionics and other electrical systems of the aircraft through the fuel tank area. These and other advantages of the present disclosure will be described in more detail herein.

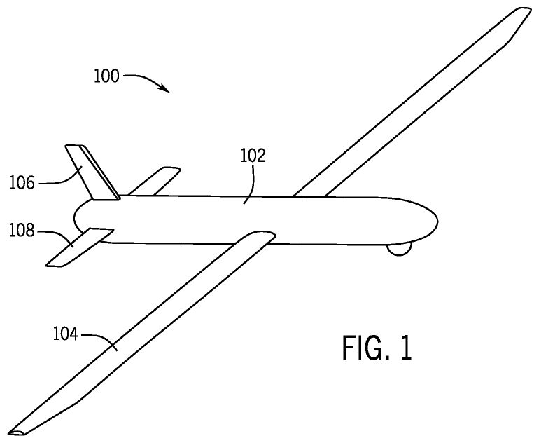

FIG. 1 illustrates a perspective view of an aircraft assembly 100. The aircraft assembly 100 is a vehicle that can achieve flight for various purposes, such as shipping, transportation, and recreation. The aircraft assembly 100 may be configured for on-board crew or may be an unmanned aerial vehicle. The aircraft assembly 100 can include a fuselage 102 that is coupled to one or more wings 104, a vertical stabilizer 106, and a horizontal stabilizer 108. The fuselage 102 can form the main body of the aircraft assembly 100 and can be used to house a crew, passengers, or cargo. The wings 104 can extend off to one or more sides of the fuselage 102 and can be used to create lift. The vertical stabilizer 106 and the horizontal stabilizer 108 can extend off the rear of the fuselage 102 and can be used to stabilize the aircraft assembly 100 during flight. In addition to these aircraft components, the aircraft assembly 100 can also include other aircraft components that can assist with flight or other operational purposes, including, for example, engines, control surfaces (such as ailerons, flaps, elevators, rudders, etc.), payload bays, booms, propellers, landing gear, frames, avionics, control systems, and communication systems. Although embodiments of the present disclosure are directed to an aircraft assembly 100, these embodiments can be directed to other vehicles, such as cars, helicopters, and watercraft.

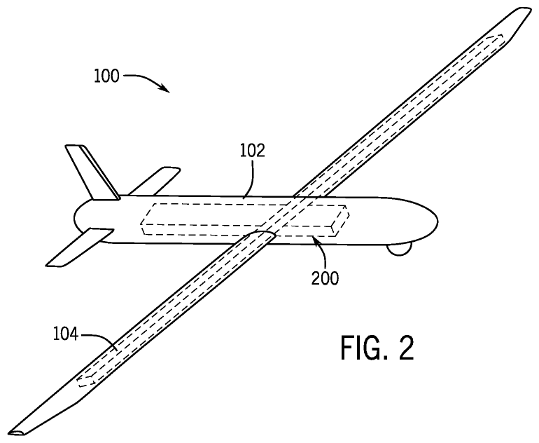

In some embodiments, the aircraft assembly 100 can require fuel for operational purposes, such as powering an engine. As illustrated in FIG. 2, the aircraft assembly 100 can include a fuel system 200 to help store and provide fuel. The fuel system 200 can be installed within the aircraft assembly 100. For example, as shown in FIG. 2, the fuel system 200 can be disposed within both the fuselage 102 and the wings 104. In various embodiments, the fuel system 200 is disposed within either the fuselage 102 or the wings 104, but not both. Additionally, or alternatively, the fuel system 200 can be attached externally to the aircraft assembly 100.

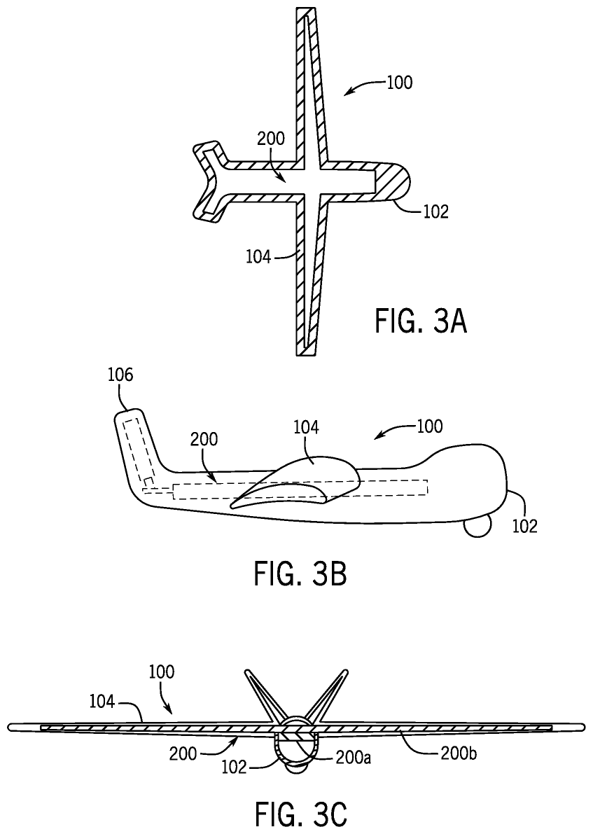

FIGS. 3A-3C illustrate various views of a fuel system 200 positioned within another example of the aircraft assembly 100. As shown in FIG. 3A, the fuel system 200 can include an interconnected system that extends between the fuselage 102 and the wings 104. FIG. 3B illustrates a fuel system 200 extending from the fuselage 102 to the vertical stabilizer 106. FIG. 3C illustrates a fuel system 200 having a first portion 200a in the fuselage 102 and a second portion 200b extending across the wings 104. These fuel system 200 layouts can provide different fuel storage capacities and allow for the designer to select the fuel system 200 layout that best meets the desired fuel capacity.

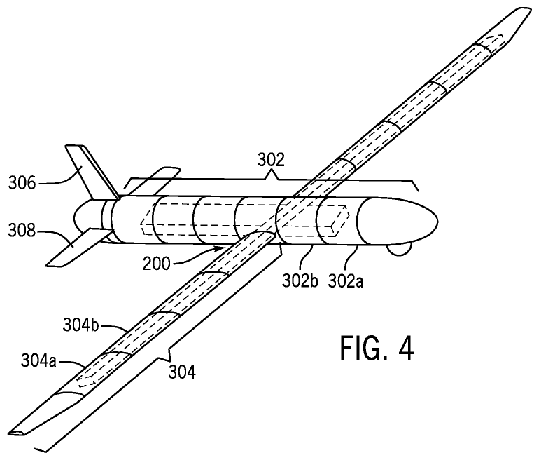

Some embodiments of the present disclosure can be directed to an additively manufactured aircraft assembly 100, designated as aircraft assembly 300. As shown in FIG. 4, examples of the additively manufactured aircraft assembly 300 generally include features of the aircraft assembly 100 as described above. For example, the aircraft assembly 300 can include a fuselage 302, wings 304, a vertical stabilizer 306, and a horizontal stabilizer 308. Notably, the components of the aircraft assembly 300 can be manufactured from an additive manufacturing process and assembled together. For example, the fuselage 302 can be assembled from one or more fuselage segments, such as the fuselage segments 302a, 302b, which are each manufactured separately by an additive manufacturing process. Similarly, the wings 304 can be assembled from one or more wing segments, such as the wing segments 304a, 304b, which are each manufactured separately by an additive manufacturing process. This manufacturing process allows for the aircraft assembly 300 to be quickly assembled and also allows for greater customization of the aircraft assembly's 300 design.

As shown in FIG. 4, the aircraft assembly 300 can include the fuel system 200. The fuel system 200 can be disposed within the aircraft assembly 300. For example, as shown in FIG. 4, the fuel system 200 can be disposed within the fuselage 302 and the wings 304. In some embodiments, the fuel system 200 can be disposed within one or more portions of the fuselage 302 or wings 304. For instance, the fuel system 200 can be disposed within the fuselage segments 302a, 302b or the wing segments 304a, 304b of the aircraft assembly 300. However, other placements of the fuel system 200 are also contemplated.

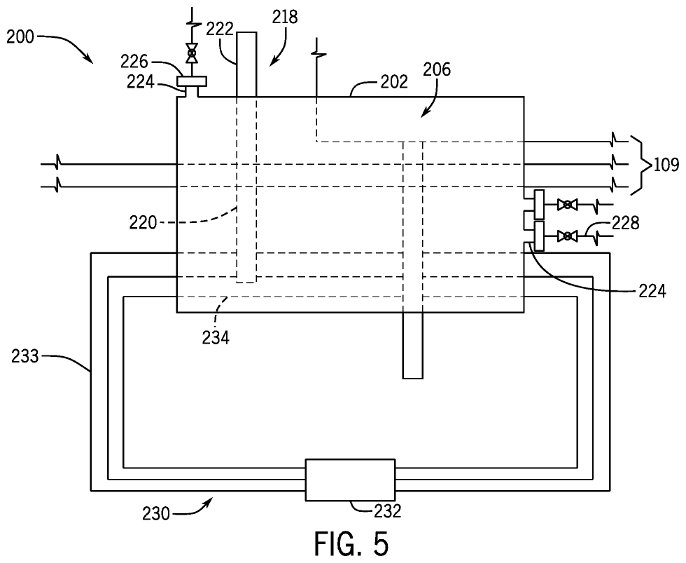

FIG. 5 illustrates a schematic illustration of a fuel system 200. In some embodiments, fuel system 200 can be used to store and provide fuel for the aircraft assembly 100. As shown in FIG. 5, the fuel system can include a fuel tank 202 that can store fuel for use. The fuel system 200 can further include additional components and systems to assist with storing and providing fuel during operation. For example, the fuel system 200 can also include a pumping system (not pictured) that couples to the fuel tank 202 and can direct fuel stored within the fuel tank 202 to the desired component or system within the aircraft assembly 100 (e.g., by pumping fuel from the fuel tank 202 to the engine). Additionally, as will be described in more detail herein, in some embodiments the fuel system 200 can include a heat exchanger system 230 that can assist, for example, with maintaining the fuel stored within the fuel tank 202 within a desired temperature range, or with cooling fluids used in other aircraft systems.

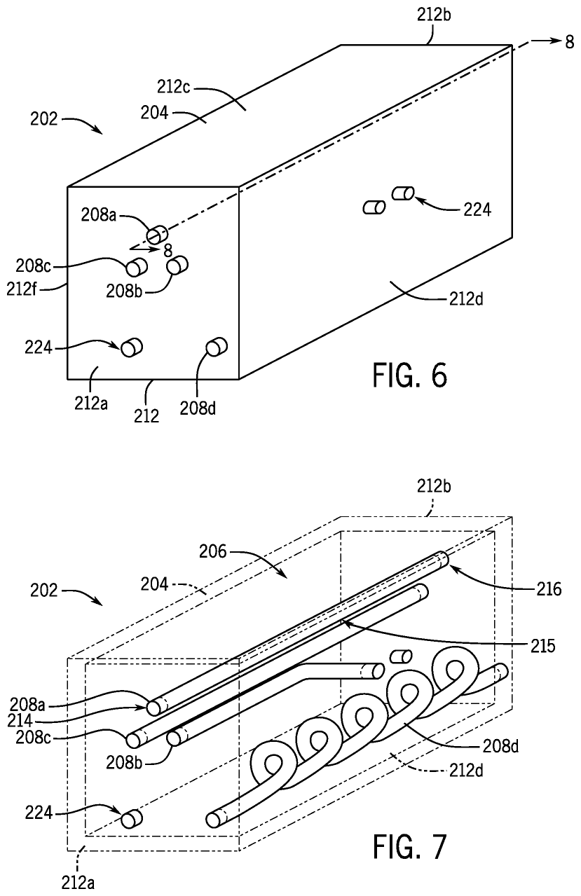

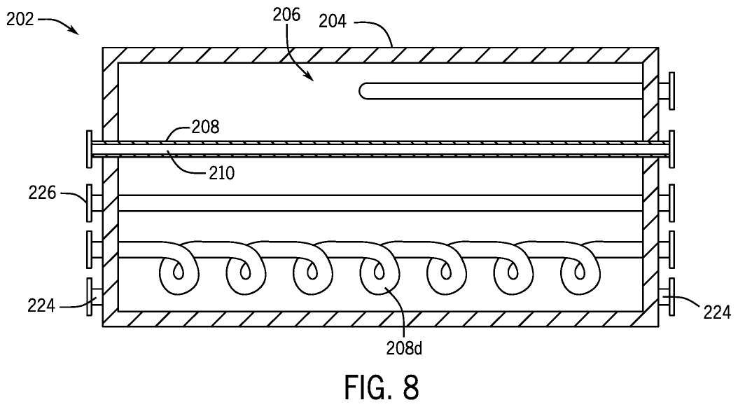

FIG. 6 illustrates a perspective view of an example of the fuel tank 202, FIG. 7 illustrates a perspective internal view of the fuel tank 202 with some components hidden for clarity, and FIG. 8 illustrates a cross-sectional view of the fuel tank 202 with some components hidden for clarity. Referring to FIGS. 5-8 together, the fuel tank 202 can have a body 204 that defines an inner chamber 206. The body 204 can form the structure of the fuel tank 202 while the inner chamber 206 can be configured to hold the fuel.

As illustrated in FIGS. 6-8, the body 204 of the fuel tank 202 can include one or more walls 212a, 212b, 212c, 212d, 212e, 212f, (collectively referred to as “the walls 212”) that form an outer perimeter of the body 204. As shown in FIG. 6, the walls 212 can couple together to form a rectangular structure. However, in some embodiments, the walls 212 can be arranged to form a different structure. For example, the walls 212 can form the body 204 having a cylindrical, spherical, conical, or other shaped structure. The walls 212 can have a specific thickness and be positioned in relation to one another so that the walls 212 form a hollow structure that defines the inner chamber 206 within the body 204. Additionally, the walls 212 can be sized and arranged in a manner to form an inner chamber 206 of any desired shape and volume.

In some embodiments, it can be beneficial to route one or more components of other aircraft systems through the fuel tank 202. In some embodiments, routing one or more components (such as an electrical wire for an avionics system, a delivery channel for hydraulic fluids, etc.) through the fuel tank 202 can create a more compact design for the aircraft assembly 100 and can improve the ease of assembly.

To address this feature, as shown in FIGS. 7 and 8, the body can also include one or more conduits 208a, 208b, 208c, 208d (collectively referred to as “the conduits 208”) that extend through the inner chamber 206 of the fuel tank 202. The conduits 208 can form a tubular structure, having a first end portion 214, a second end portion 216, and an intermediate portion 215 extending between the first and second end portions 214, 216.

Each conduit 208 defines a corresponding channel 210. The channel 210 can be isolated from fluid communication with the inner chamber 206 so that the contents of the channel 210 do not contact the fuel in the inner chamber 206. In some examples, the channels 210 can extend through the wall 212 to an exterior of the fuel tank 202. Accordingly, the conduits 208 can provide an area within the fuel tank 202 through which one or more components of other systems of the aircraft assembly 100 can be routed.

The conduits 208 can have an aperture formed through the length of the conduits 208. This aperture can define the corresponding channel 210 within each of the conduits 208. The channel 210 can be selectively sized and shaped during the additive manufacturing process to accommodate various desired items within. For example, the channel 210 can be sized to receive an electrical wire or a fluid therethrough.

The conduits 208 can be formed to extend outwardly from one or more of the walls 212 to facilitate access and/or coupling to the conduits 208 and the channels 210. For example, the first end 214 of the conduit 208a can be positioned outwardly from the wall 212a and the second end 216 can be positioned outwardly from the wall 212b. Alternatively, one or more of the conduits 208 may terminate flush with the corresponding wall 212.

The conduits 208 can extend to and from different walls 212 of the body 204. In some embodiments, one or more of the conduits 208 can be formed between opposing walls 212. For example, the conduit 208a can extend from wall 212a to the opposing wall 212b. Additionally or alternatively, one or more of the conduits 208 can extend between non-opposing walls 212. For instance, the conduit 208b can extend from wall 212a to a non-opposing wall 212d. Arranging the conduits 208 in this manner allows for the user to route a component, such as the avionics 109 (see FIG. 5) or other component or fluid through the conduit 208 and to a desired location within the aircraft assembly 100. For example, if the fuel tank 202 is positioned in the wing 104 of the aircraft, an avionics control line can be routed in through wall 212a, which may be adjacent to a root of the wing 104, through the fuel tank 202 and then routed out through wall 212d, which may be adjacent to a control surface positioned on the back of the wing 104.

As will be discussed in more detail below, the conduits can be formed in the same additive manufacturing process that forms the walls 212. In other word, end portions 214, 216 of the conduits 208 can be monolithically formed with corresponding ones of the walls 212, and intermediate portions 215 of the conduits can be likewise monolithically formed and can extend unsupported within the inner chamber 206 between end portions 214, 216. In certain embodiments, the unsupported intermediate portion 215 of the conduits 208 may be formed using the various systems and methods disclosed in one or more of U.S. patent application Ser. No. 16/255,605, filed Jan. 23, 2019 and entitled “ADDITIVELY MANUFACTURED STRUCTURE AND METHOD FOR MAKING THE SAME” and U.S. patent application Ser. No. 16/538,681, filed Aug. 12, 2019 and entitled “ADDITIVELY MANUFACTURED STRUCTURE AND METHOD FOR MAKING THE SAME,” both of which are assigned to the current Applicant and both of which are expressly incorporated by reference herein in their entirety.

In some embodiments, the fuel tank 202 can include one or more reinforcing members 218. The reinforcing member 218 can be coupled to the body 204 and can provide structural support to the fuel tank 202 and aircraft assembly 100. In some embodiments, the one or more reinforcing members 218 include a baffle 220 configured to reduce sloshing of fuel stored within the inner chamber 206 of the body 204. At least a portion of the baffle 220 can extend into the inner chamber 206 of the body 204. Additionally, the baffle 220 can extend from one wall 212 of the body 204 and terminate at a distance from a second wall 212 of the body 204. For example, the baffle 220 can extend from the wall 212f of the body 204 and terminate at a distance from the wall 212d. The distance between the baffle 220 and the second wall is selected to allow for fuel within the inner chamber 206 to flow around the baffle 220 at a sufficient flow rate, while also reducing sloshing of the fuel within the inner chamber 206.

In certain embodiments, the one or more reinforcing members 218 include a rib 222 that extends outwardly from the body 204 and can align with other components of the aircraft assembly 100, including the baffle 220. In some examples, the rib 222 can align, and couple, with a rib (not shown) within the fuselage 102 or wing 104. In various embodiments, the rib 222 thus cooperates with a structural element (e.g., the rib, frame, etc.) of the fuselage 102 or wing 104 to improve a structural performance of the fuel tank and/or the vehicle. Arranging the rib 222 in any one of these manners may beneficially increase a resistance of the fuel tank 202 and the aircraft assembly 100 to bending.

In some embodiments, the fuel tank 202 can include one or more ports 224 defined in the walls 212 of the body 204, which provide access to the inner chamber 206 of the body 204. As shown in FIGS. 5-8, the ports 224 are in fluid communication with the inner chamber 206 and an exterior of the fuel tank 202. Accordingly, these ports 224 can include input ports 224 that enable the fuel tank 202 to be filled with fuel, and outport ports 224 that enable the fuel system 200 to pump fuel out of the inner chamber 206 to an engine. In some embodiments, the output ports 224 can be located at more than one location along the body 204. For example, locating output ports 224 on different walls 212 of the body 204 may facilitate more reliable pumping of fuel from the inner chamber 206 regardless of a fuel level within the inner chamber 206 or an orientation of the aircraft assembly 100. In some embodiments, one or more of the ports 224 can include a valve for a variety of purposes. For example, the ports 224 can include a valve to equalize the pressure within the inner chamber 206 by, for instance, bleeding air into or out of the inner chamber 206.

In various embodiments, one or more fittings 226 can be coupled to the ports 224 to allow lines (such as a fuel line 228) or other components (e.g., a pump, hose, etc.) to fluidly couple to the inner chamber 206. As illustrated in FIGS. 5-8, the fittings 226 can be positioned outwardly from the ports 224 to facilitate access to the fittings 226. As will be discussed in more detail herein, in some embodiments, the fittings 226 can be monolithically formed with the walls 212, which can limit leaks and seal the fittings 226 to the ports 224.

As illustrated in FIG. 5, in some embodiments, the fuel system 200 can include a heat exchanger system 230 that couples to the fuel tank 202. As previously mentioned, in some embodiments, the heat exchanger system 230 can be used to adjust the temperature of the fuel within the fuel tank 202 so that the stored fuel is maintained within a desired temperature range. For example, the heat exchanger system 230 can include a heat source 232. In some examples, the heat source 232 includes a pump that directs a heat transfer fluid through the channel 210 defined by the conduit 208d (e.g., as shown in FIG. 7). Accordingly, in various examples, one or more of the conduits 208 can form at least a portion of the heat exchanger system 230.

A wall thickness of the conduit 208d may be selected to facilitate heat transfer between the heat transfer fluid and the fuel stored in the inner chamber 206. Additionally, in certain embodiments, the conduit 208d may have a coil shape to provide an increased surface area over which the heat transfer occurs. The heat source 232 may also include a separate mechanism (not shown) to adjust the temperature of the heat transfer fluid in order to obtain the desired heat transfer with the stored fuel. Additionally or alternatively, the heat transfer fluid may be a fluid from another vehicle system, such as hydraulic fluid or engine oil, that absorbs heat through the normal operation of the vehicle. In some such embodiments, the heat exchanger system 230 performs a dual intended purpose of heating the stored fuel and cooling the hydraulic fluid. Utilizing fluids from other components of the aircraft assembly 100 can create a more efficient and compact design of the heat exchanger system 230.

In some examples, the heat exchanger system 230 can include tubing 233 that is coupled in fluid communication between the heat source 232 and the conduit 208d. The tubing 233 can be used to route the heat transfer fluid to and from the heat source 232.

In various examples, the heat exchanger system 230 includes one or more heating elements 234 for generating heat. The heating element 234 can be a wound-up wire or metallic material that can generate heat when a current passes through the wire or metallic material. In certain examples, the heat source 232 can provide the electrical current to the heating element to generate heat. In some embodiments, the heating element 234 may be positioned within a channel 210 of a corresponding conduit 208 and routed through the inner chamber 206 of the body 204. The conduit 208 walls may be configured to electrically isolate the heating element 234 from the stored fuel, while enabling heat transfer from the heating element 234 to the stored fuel.

In some embodiments, the heat exchanger system 230 can include additional components or systems to assist with controlling the temperature of the fuel stored within the inner chamber 206 of the fuel tank 202. For example, the heat exchanger system 230 can include a control system having one or more temperature sensors that can determine the temperature of the fuel within the inner chamber 206. Additionally, in certain embodiments, the heating source 232 can be configured as a heat exchanger that can generate and deliver heat to the fuel within the inner chamber 206.

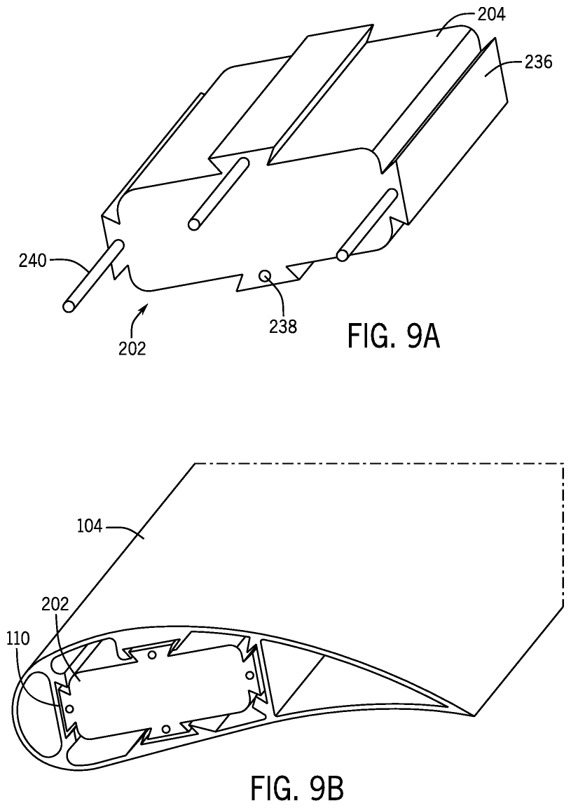

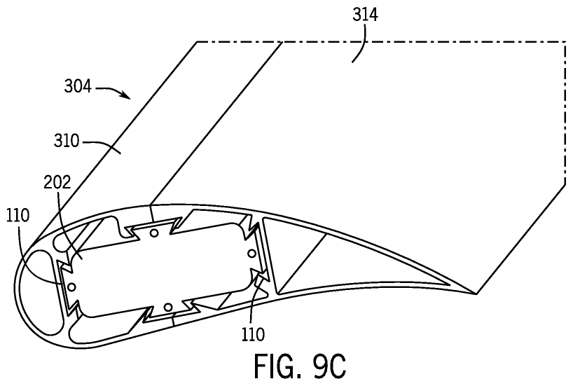

As previously discussed, the fuel system 200 can be disposed within the aircraft assembly 100. In some embodiments, the fuel system 200 can be configured to be disposed within a specific component of the aircraft assembly 100, including, for example, the fuselage 102 and the wings 104. FIGS. 9A-14 illustrate several non-limiting examples of coupling the fuel system 200 to the aircraft assembly 100.

FIG. 9A illustrates a perspective view of a fuel tank 202, FIG. 9B illustrates the fuel tank 202 from FIG. 9A installed within an example wing 104, and FIG. 9C illustrates the fuel tank 202 from FIG. 9A installed within another example wing 104. Referring to FIGS. 9A-9C together, the fuel tank 202 can include one or more coupling portions 236 that are formed along the outer perimeter of the body 204 of the fuel tank 202. These coupling portions 236 can be configured to couple the fuel tank 202 to a component of the aircraft assembly 100. For example, as shown in FIG. 9B, the coupling portions 236 can be slidably received within the wing 104 to couple the fuel tank 202 with the wing 104.

As shown in FIG. 9B, the wing 104 can include one or more body coupling portions 110. These body coupling portions 110 can be configured to mate to the coupling portions 236 in order to couple the fuel tank 202 to the wing 104. For example, the body coupling portions 110 can form a receiving area that corresponds to the shape of the coupling portions 236, which allows for the body coupling portions 110 to slidably receive the coupling portions 236 and thus slidably couple the fuel tank 202 to the wing 104. In some examples, the coupling portions 236 form a wedge-like profile that increases in width as the coupling portions 236 extends further way from the body 204 of the fuel tank 202. This wedge-like profile interlocks with the corresponding wedge-like profile of the body coupling portions 110 to facilitate securing the fuel tank 202 to the component of the aircraft assembly 100.

In some examples, portions of the wing 104 can be assembled around the fuel tank 202 to improve ease of assembly of the aircraft assembly 100. As illustrated in FIG. 9C, the wing 104 can include an example embodiment of an additively manufactured wing 304 (shown in FIG. 4). In the illustrated example, a first wing portion 310 has an outer surface that forms the leading edge of the wing 304 and an inner surface that includes a first body coupling portion 110. The first body coupling portion 110 can slidably couple to, and interlock with, a first coupling portion 236 of the fuel tank 202 as described above. The wing 304 can further include a second wing portion 314 having an outer surface that forms the trailing edge of the wing 304 and an inner surface which includes a second body coupling portion 110. The second body coupling portion 110 can slidably couple to, and interlock with, a second coupling portion 236 of the fuel tank 202, as described above.

Coupling the first and second wing portions 310, 314 separately to the fuel tank 202 can improve various aspects of assembling an aircraft assembly 100, 300. Because the first and second wing portions 310, 314 can be coupled separately, these portions can also be manufactured separately as two individual components. For example, leading edge and trailing edge profiles can be tailored and quickly additively manufactured for mission-specific wing 104 designs, without requiring any changes to the fuel tank 202 design. Manufacturing these components separately also can lead to improved production times, decreased complexity of the part design, and improved handling for installation due to the decreased size of the parts.

Referring again to FIG. 9A, in some embodiments, the coupling portion 236 can include a channel 238 formed within the coupling portion 236 that extends throughout the length of the coupling portion 236. The fuel system 200 can include a reinforcing rod 240 inserted within the channel 238 of the coupling portion 236 along at least a portion of the length of the channel 238. Positioning the reinforcing rod 240 within the channel 238 can increase the rigidity of the fuel tank 202 and, in some examples, the rigidity of the surrounding aircraft component. In some embodiments, the reinforcing rods 240 can also be used to couple together different portions of the fuel tank 202, as will be described in more detail.

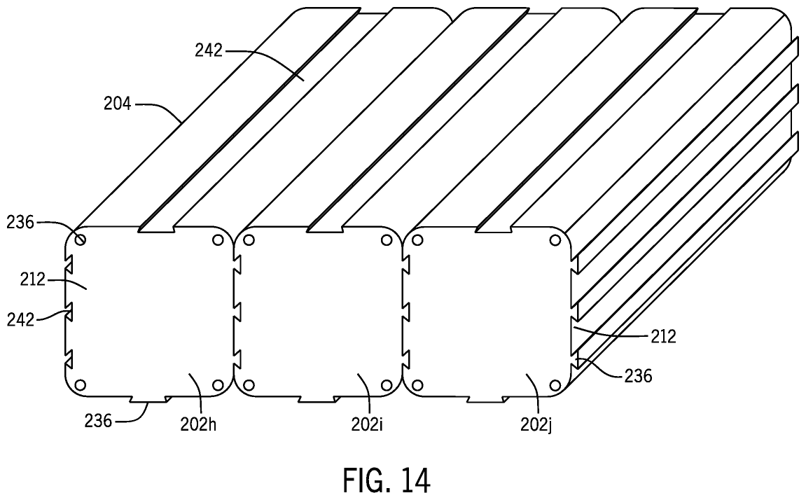

Additionally or alternatively, the channel 238 of at least one of the coupling portions 236 can be configured to receive a component, such as an electrical wire or fluid, within. As shown in FIG. 9A, the channel 238 can be formed adjacent to the external surface of the body 204, and thus, the channel 238 can isolate components received within the channel 238 from fuel stored within the inner chamber 206. Accordingly, channel 238 can be used for purposes similar to those described above with respect to channel 210. In some embodiments, the channel 238 can be formed directly within the walls 212 of the fuel tank 202, rather than within the coupling portion 236. For example, as illustrated in FIG. 14, the walls 212 define a rectangular cross-section and the channel 238 can be formed in corner portions of the walls 212.

In some embodiments, the reinforcing rod 240 can be used to couple multiple fuel tanks 202 together within the aircraft assembly. For example, the reinforcing rod can extend beyond the ends of a first channel 238 of a first fuel tank 202 and can be received in a second channel 238 of a second fuel tank 202 to couple the first fuel tank 202 to the second fuel tank 202.

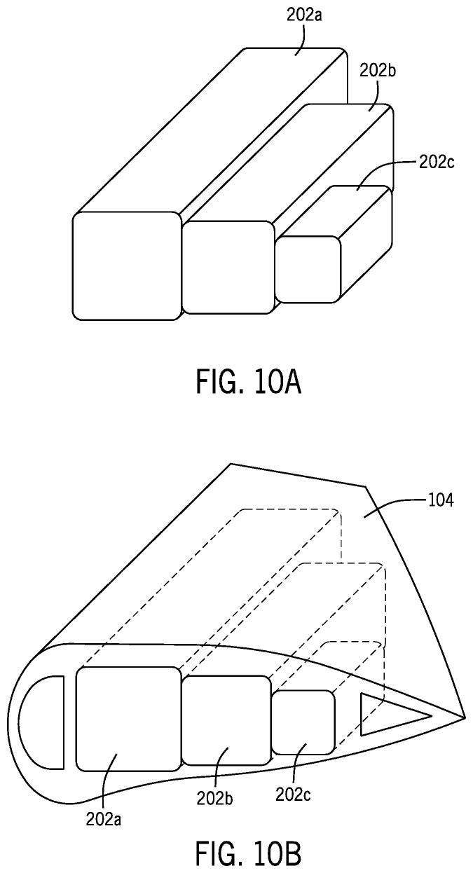

In various embodiments, the fuel system 200 can conform to the profile of a wing 104. For example, as illustrated in FIGS. 10A and 10B, the fuel system 200 can include multiple fuel tanks 202a, 202b, 202c that decrease in size along the chord length of the wing 104 so that the fuel tanks 202a—c conform to the profile of the wing 104. Utilizing multiple fuel tanks 202 within the fuel system 200 as illustrated can decrease the complexity of the fuel tank 202 design without significantly decreasing the overall fuel storage capacity of the fuel system 200.

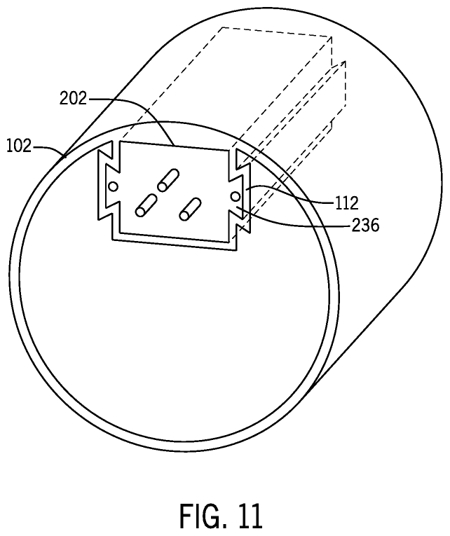

FIG. 11 illustrates a perspective view of a fuel tank 202 installed within a fuselage 102. As shown in FIG. 11, the coupling portions 236 of the fuel tank 202 can be configured to couple the fuel tank 202 to the fuselage 102. The fuselage 102 can include one or more body coupling portions 112. These body coupling portions 112 can be configured to mate to the coupling portions 236 in order to couple the fuel tank 202 to the fuselage 102, as described above with respect to the body coupling portions 110 included in the wing 104.

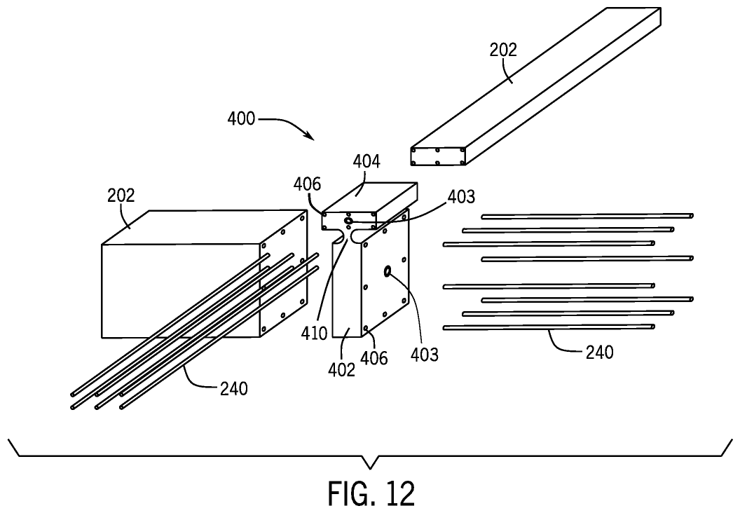

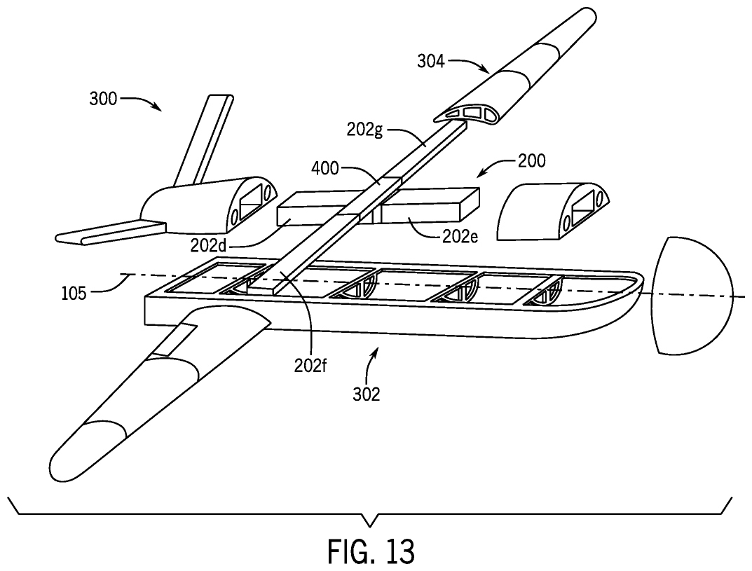

FIG. 12 illustrates a connection bracket 400 that can be used to assemble the fuel system 200 within both the fuselage 102 and the wings 104 of the aircraft assembly 100. FIG. 13 illustrates an exploded view of the aircraft assembly 100 including the example fuel tank 202 assembled with the connection bracket 400. With reference to FIGS. 12 and 13, the connection bracket 400 can include a first coupling portion 402 formed at a first end of the connection bracket 400 and a second coupling portion 404 formed at a second end of the connection bracket. The first and second coupling portions are joined at an intermediate portion 410 disposed therebetween. The connection bracket 400 may be monolithically formed, for example, by additive manufacturing, or coupling portions 402 and 404 can be formed separately and welded or bonded together at the intermediate portion 410, for example. Coupling portions 402 and 404 can each be configured to couple together a plurality of fuel tanks 202.

For example, in the example illustrated in FIGS. 12 and 13, the first coupling portion 402 has a frame shape oriented normal to a fuselage axis 105, and the second coupling portion 404 also has a frame shape oriented transverse to the fuselage axis 105. More specifically, the first coupling portion 402 is sized and oriented to couple between separate additively manufactured fuel tanks 202d and 202e positioned in the fuselage 102, and the second coupling portion 404 is sized and oriented to couple between separate additively manufactured fuel tank portions 202f and 202g positioned in the wings 104. Although the coupling portions and fuel tanks have rectangular cross-sections in the example, other shapes for the fuel tanks and corresponding coupling portions are also contemplated.

The connection bracket 400 can include one or more apertures 406 formed around the perimeters of the coupling portions 402, 404. Each aperture 406 can receive a reinforcing rod, such as the reinforcing rods 240 described above, therethrough. The reinforcing rods 240 can extend through the apertures 406 and into the channels 238 formed on each of the fuel tanks 202d-g, thereby coupling the fuel tanks 202d-g to the connection bracket 400. In the illustrated example, the fuel system 200 includes a first plurality of reinforcing rods 240 coupling the first coupling portion 402 to fuel tanks 202d and 202e positioned in the fuselage 302, and a second plurality of reinforcing rods 240 coupling the second coupling portion 404 to fuel tanks 202f and 202g positioned in the wings 304. The second plurality of reinforcing rods 240 can be oriented transversely to the first plurality of reinforcing rods 240, corresponding to the different directions in which the fuel tank 202 portions extend within the fuselage 302 and wings 304.

Although the connection bracket 400 is illustrated as including two coupling portions 402, 404 each connecting two fuel tanks 202, embodiments in which the connection bracket 400 includes a single coupling portion (e.g., connecting fuel tanks 202 in the fuselage 102 or connecting fuel tanks 202 in the wings 104) are also contemplated. Additionally or alternatively, embodiments in which more than one connection bracket 400 is used to couple together three, four, or more fuel tanks 202 are also contemplated.

In some embodiments, the connection bracket 400 can facilitate fluidly coupling a first fuel tank 202 to a second fuel tank 202. More specifically, with reference also to FIG. 7, the first and second fuel tanks can include ports 224 in their respective walls 212 that face the coupling portion 402 or 404, and the connection bracket 400 can define a passthrough region 403 for routing a flow connector (e.g., a hose or tube) between the ports. For example, in the illustrated embodiment, the first coupling portion 402 defines a first passthrough region 403 central to the frame shape of the coupling portion and extending therethrough, and the second coupling portion 404 defines a second pass-through region 403 central to the frame shape of the coupling portion and extending therethrough. The first passthrough region 403 is oriented to enable a first flow connector to couple in flow communication between ports defined in fuel tanks 202d and 202e positioned in the fuselage 102, and the second passthrough region 403 is oriented to enable a second flow connector to couple in flow communication between ports defined in fuel tanks 202f and 202g positioned in the wings 104. Fluidly coupling the inner chambers 206 of the fuel tanks 202 together via the passthrough regions 403 of the connection bracket 400 enables for the fuel system 200 to move fuel from one fuel tank 202 to the other fuel tank 202 as needed.

Similarly, the passthrough region 403 can enable routing of components in series through the channels 210 defined by the one or more conduits 208 (see FIG. 7) of multiple fuel tanks 202. For example, in the illustrated example, the first passthrough region 403 is oriented to enable a first set of one or more electrical wires to extend continuously through the channel 210 defined in the conduit 208a of fuel tank 202d, through the first passthrough region 403, and through the channel 210 defined in the conduit 208a of fuel tank 202e. Additionally, the first passthrough region 403 enables a continuous flow path for a heat transfer fluid through the channel 210 defined in the conduit 208d of fuel tank 202d, through a flow connector positioned in the first passthrough region 403, and through the channel 210 defined in the conduit 208d of fuel tank 202e. Accordingly, a single heat source 232 may be coupled in series to multiple fuel tanks 202. The second passthrough region 403 enables a similar arrangement through the respective conduits 208 of fuel tanks 202f and 202g positioned in the wings 104. Moreover, in some embodiments, an additional passthrough region (not shown) may be defined through the intermediate portion 410, enabling further routing of components in series through the channels 210 defined by the one or more conduits 208 of, for example, fuel tank 202e positioned in the fuselage 102 and fuel tank 202f positioned in the wing 104.

In some embodiments, the fuel system 200 can include one or more fuel tanks 202 that are configured to be directly coupled to one other. For example, as shown in FIG. 14, the fuel system 200 can include first, second, and third fuel tanks 202h, 202i, 202j that are directly interlocked to one another. The fuel tanks 202h—j can each include one or more receiving portions 242 that are formed around the perimeter of the body 204 of each fuel tank 202h—j. These receiving portions 242 can be configured to mate to a corresponding coupling portion 236 on an adjacent fuel tank, which allows for each fuel tank 202h—j to slidably couple to the adjacent fuel tank. In some embodiments, these receiving portions 242 allow for the fuel tanks 202h—j to be securely stacked on top of one another. Arranging the fuel system 200 as illustrated can decrease the complexity of the fuel tank 202 design while also allowing for the manufacturer to adjust the fuel storage capacity of the fuel system 200 as necessary (e.g., by adding or removing one or more fuel tanks 202 to the system).

In some embodiments, it can be beneficial to form the fuel tank 202 from an additive manufacturing process. Forming the fuel tank 202 in this manner can lead to several advantages over conventional manufacturing processes. For example, an additive manufacturing process can allow for the fuel tank 202 to have a more complex design. Additionally, this manufacturing process can greatly improve the production rate for manufacturing fuel tanks 202, even despite the more complex design. Furthermore, in some instances, this additive manufacturing process can create a fuel tank 202 that forms a monolithic structure. In other words, the entire fuel tank 202 (e.g., the body 204, the conduits 208, ports 224, fittings 226, etc.) can form a single component with a monolithic structure. This monolithic structure can have several advantages, including, for example, reducing a number of joints along the fuel tank 202 that need to be sealed for leaks. Additional advantages may be realized through this manufacturing process.

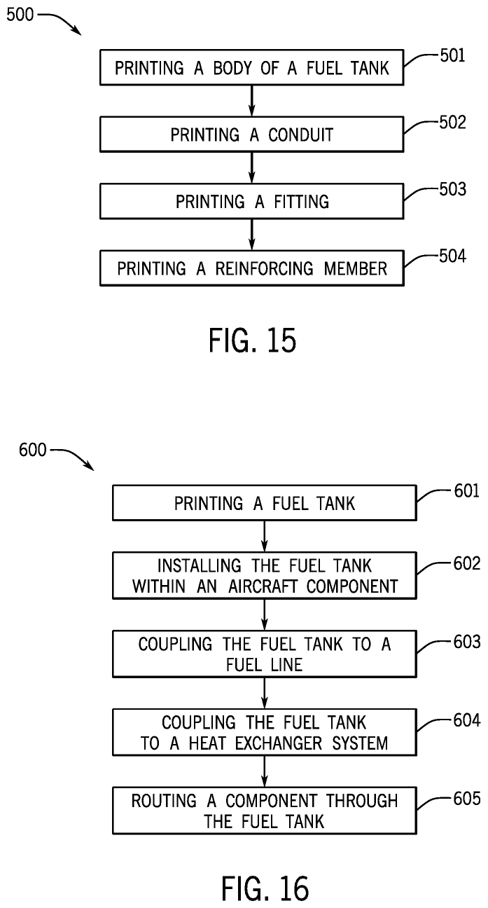

FIG. 15 is a flow diagram illustrating an example method 500 of manufacturing a fuel tank, such as embodiments of the fuel tank 202 as described herein. The method 500 can be performed using any desired additive manufacturing process, including, for example, extrusion deposition, binder jetting, powder fusion, or other 3D printing or additive process.

At step 501, the method 500 begins with printing a body of a fuel tank using an additive manufacturing process. As previously described with respect to FIGS. 5-8, the fuel tank (e.g., the fuel tank 202) can include a body (e.g., the body 204) that defines an inner chamber (e.g., the inner chamber 206) for storing fuel. Accordingly, at step 501, this body and inner chamber can be formed through the additive manufacturing process. In some embodiments, the additive manufacturing process can be used to form several features of the body at step 501. For example, the additive manufacturing process can be used to form one or more coupling portions (e.g., the coupling portions 236). In certain embodiments, step 501 optionally includes defining a port extending from outside the body into fluid communication with the inner chamber. For example, as the walls (e.g., the walls 212) of the body are printed, the additive manufacturing process can be programmed to not deposit material in locations selected for the ports, thereby forming one or more passageways that extend through the wall of the body to provide access to the inner chamber. In some examples, the port can be defined on a first end portion of the body of the fuel tank.

At step 502, the method 500 optionally includes printing, during printing of the body of the fuel tank using the additive manufacturing process, a conduit that is monolithic with the body of the fuel tank. In some examples, the conduit defines a channel that is not in fluid communication with the inner chamber. As previously described with respect to FIGS. 6-8, the fuel tank can include one or more conduits (e.g., the conduits 208) that form one or more channels (e.g., the channels 210), e.g., for routing components through the fuel tank. Accordingly, at step 502, these conduits and channels can be formed through the additive manufacturing process.

In some embodiments: (a) the additive manufacturing process includes a plurality of layer deposition steps; (b) the step 501 of printing the body includes depositing a plurality of body layers; or (c) the step 502 of printing the conduit includes depositing a plurality of conduit layers. The method 500 may further include depositing each of the conduit layers in a same layer deposition step of the additive manufacturing process as a respective one of the plurality of body layers. Alternatively, the method 500 may further include depositing at least one of the conduit layers in a layer deposition step of the additive manufacturing process that does not include depositing any of the plurality of body layers. As a non-limiting example, with reference also to FIGS. 6 and 7, a first plurality of deposition steps could include printing wall 212a generally flush with a printer bed and printing a portion of one or more of walls 212c-f vertically from wall 212a, and a separate second plurality of layer deposition steps could include printing portions of one or more of conduits 208a, 208b, 208c, 208d vertically from wall 212a.

The method 500 can optionally include, at step 503, printing a fitting monolithic with the body during the additive manufacturing process. In some examples, this fitting is configured to couple a hose in fluid communication with the inner chamber via the port. As previously described with respect to FIGS. 5-8, the fuel tank can include one or more ports (e.g., the port 224) for enabling fluid communication with the inner chamber of the fuel tank. Likewise, as previously described with respect to FIGS. 5-8, the fuel tank can include a fitting (e.g., the fitting 226) to assist with fluidly coupling a fuel line (e.g., the fuel line 228) or other component to the inner chamber via the port. These fittings can be formed through the additive manufacturing process. In certain examples, the fittings can be arranged on an external end of the port so that the fitting can fluidly couple a component to the inner chamber, as illustrated with the fitting 226 in FIG. 7.

At step 504, the method 500 optionally includes printing, during the additive manufacturing process, a reinforcing member monolithic with the body. As previously described with respect to FIGS. 5-8, the fuel tank can include a reinforcing member (e.g., the reinforcing member 218). In some embodiments, at least a portion of the reinforcing member forms a baffle within the inner chamber of the body, such as the baffle 220 illustrated in FIG. 5, for example, to limit sloshing of fuel held within the inner chamber. Additionally, or alternatively, the step 504 includes printing a rib that extends outwards from an outer surface of the body of the fuel tank, such as the rib 222 illustrated in FIG. 5. This reinforcing member, including the baffle and ribs, can be formed through the additive manufacturing process.

In various embodiments, a step 501-504 of the method 500 can be completed in parallel with another step 501-504 from the method 500, that is, during the same additive manufacturing process. By depositing layers of one or more of the conduits, the ports, the fittings, or the reinforcing members during the deposition steps that are used to form the body (or during the same additive manufacturing process), the one or more of the conduits, ports, fittings, and reinforcing members can be monolithically formed with the body. In other words, the body and the one or more of the conduits, ports, fittings, and reinforcing members can form a monolithic structure after the additive manufacturing process is completed, thereby improving a speed of manufacture and reducing a need for a separate sealing process against leakage where such components connect to the fuel tank.

Alternatively, at least some components of the fuel tank can be formed separately and assembled together after formation. For example, one or more of the components can be formed separately from the body of the fuel tank and then assembled together to form the desired structure.

In various embodiments, the material used in the additive manufacturing process to form the fuel tank and its components can be a material that is nonreactive to fuel. For example, the body of the fuel tank can be formed from high density polyethylene (HDPE). Additionally, or alternatively, suitable treatments can be applied to an interior of the walls 212 to provide or improve the nonreactivity of the material to fuel. Other suitable materials may be used to form the fuel tank and its components.

FIG. 16 is a flow diagram illustrating an example method 600 of manufacturing a fuel system for an aircraft. The method 600 can be performed to manufacture any of the fuel system embodiments described herein, including the fuel system 200 described in FIGS. 1-14.

At step 601, the method beings with printing a fuel tank. As previously described with respect to FIGS. 5-8, the fuel tank (e.g., the fuel tank 200) can include a body (e.g., a body 204) that defines an inner chamber (e.g., the inner chamber 206) for storing fuel. To form the fuel tank, a manufacturer can use an additive manufacturing process to print the fuel tank and any of its components. In some examples, the manufacturer can include one or more of the steps described in the method 500 when printing the fuel tank at step 601.

At step 602, the method continues with installing the fuel tank within an aircraft component. In some embodiments, installing the fuel tank within an aircraft component includes coupling the fuel tank to the aircraft component. As previously discussed above with respect to FIGS. 9-14, the fuel tank can include one or more coupling portions (e.g., the coupling portions 236) which can couple to a corresponding body coupling portion (e.g., the body coupling portions 110, 112) of the fuselage (e.g., the fuselage 102, 302) or wings (e.g., the wings 104, 304) of an aircraft. Accordingly, in some examples, the fuel tank can be installed within an aircraft component by slidably coupling the fuel tank to the fuselage or to the wing.

At step 603, the method optionally includes coupling the fuel tank to a fuel line. Once the fuel tank is disposed within the aircraft component, the inner chamber of the fuel tank can then couple to a fuel line (e.g., the fuel line 228) of the aircraft so that the inner chamber of the fuel tank is in fluid communication with the fuel line of the aircraft. By fluidly coupling the inner chamber of the fuel tank with the fuel line, fuel stored within the inner chamber can then be directed to another system within the aircraft, such as an engine, by forming a fluid path for fluid to flow from the fuel tank to the other system.

At step 604, the method optionally includes coupling the fuel tank to a heat exchanger system. As previously described with respect to FIG. 5, the fuel system can include a heat exchanger system (e.g., the heat exchanger system 230) for adjusting the temperature of the fuel held within the inner chamber of the fuel tank, and/or for cooling a fluid of another aircraft system via heat transfer to the stored fuel, for example. In some examples, coupling the fuel system to the heat exchanger system can include fluidly coupling the heat exchanger system to a channel defined by a conduit of the fuel tank. In some of these examples, or otherwise, the conduit can be configured to enable heat exchange between the fuel stored within the inner chamber and a fluid that is routed through the channel by the heat exchanger system. Accordingly, in some examples, the conduit can form at least a portion of the heat exchanger system when the heat exchanger system is fluidly coupled to the body of the fuel tank.

In various embodiments, coupling the fuel tank to the heat exchanger system can include routing a heating element through a conduit of the fuel tank. As previously described with respect to FIGS. 5-8, a heating element (e.g., the heating element 234) can be routed through the channel defined by a conduit of the fuel tank to provide heat to the fuel stored with the inner chamber of the fuel tank.

At step 605, the method optionally includes routing a component through the fuel tank. As previously described with respect to FIGS. 5-8, one or more components (e.g., electrical wire, avionics, hydraulic fluid, etc.) can be routed through the conduits of the fuel tank. In some embodiments, this step 605 is performed before the fuel tank is coupled to the aircraft component. In other embodiments, this step 605 is performed after the fuel tank is installed within the aircraft component.

This disclosure is not intended to be exhaustive or to limit the present technology to the precise forms disclosed herein. For instance, although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Furthermore, although steps of methods may be presented herein in a particular order, in alternative embodiments the steps may have another suitable order, including being performed concurrently in a parallel process when possible.

Certain aspects of the present technology disclosed in the context of particular embodiments can be combined or eliminated in other embodiments. Furthermore, while advantages associated with certain embodiments may have been disclosed in the context of those embodiments, other embodiments can also exhibit such advantages, and not all embodiments need necessarily exhibit such advantages or other advantages disclosed herein to fall within the scope of the present technology. The embodiments have been particularly shown and described, but it will be understood that various changes in form and details may be made. For example, although various embodiments have been described as having particular features and/or combinations of components, other embodiments are possible having any combination or sub-combination of any features and/or components from any of the embodiments described herein. The specific configurations of the various components can also be varied. For example, the size and specific shape of the various components can be different than the embodiments shown, while still providing the functions as described herein. Furthermore, in some examples, the illustrations describing some embodiments can hide particular features of the embodiment so as to not obscure the illustration of other features within the embodiment. Accordingly, this disclosure and associated technology can encompass other embodiments not expressly shown and/or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments. Where appropriate, relative terms, such as “about,” “substantially,” and “approximately,” can be understood to incorporate standard tolerances. For example, two members that are “substantially parallel” may be understood to mean two members that are parallel within standard engineering tolerances.

1. A fuel system for an aircraft, the fuel system made by an additive manufacturing process, the fuel system comprising:
a fuel tank having a body defining an inner chamber configured to store fuel; and
a conduit formed monolithically with the body during the additive manufacturing process, the conduit extending within the inner chamber, wherein the conduit defines a channel that is not in fluid communication with the inner chamber.

2. The fuel system of claim 1, wherein the body includes opposing first and second walls, and wherein the conduit extends within the inner chamber from the first wall to the second wall.

3. The fuel system of claim 1, wherein the body includes non-opposing first and third walls, and wherein the conduit extends within the inner chamber from the first wall to the third wall.

4. The fuel system of claim 1, further comprising a heat exchanger system coupled to the body of the fuel tank, wherein the conduit forms at least a portion of the heat exchanger system.

5. The fuel system of claim 4, wherein the heat exchanger system is fluidly coupled with the channel, and wherein the conduit is configured to enable heat exchange between fuel stored in the inner chamber and a fluid routed through the channel by the heat exchanger system.

6. The fuel system of claim 4, wherein the heat exchanger system includes a heating element routed through the conduit.

7. The fuel system of claim 1, further comprising a reinforcing member formed monolithically with the body during the additive manufacturing process, wherein at least a portion of the reinforcing member is a baffle extending into the inner chamber of the body of the fuel tank.

8. The fuel system of claim 7, wherein at least a second portion of the reinforcing member is a rib extending outwards from an outer surface of the body of the fuel tank, wherein the rib is aligned with the baffle.

9. (canceled)

10. The fuel system of claim 1, wherein the channel is sized to receive an electrical wire therethrough, and wherein the conduit is configured to isolate the electrical wire from fuel stored in the inner chamber of the body.

11. (canceled)

12. A method of manufacturing a fuel system for an aircraft, the method comprising:
printing, using an additive manufacturing process, a body of a fuel tank, the body of the fuel tank defining an inner chamber configured to store fuel; and
during printing of the body of the fuel tank, printing, using the additive manufacturing process, a conduit that is monolithic with the body of the fuel tank, wherein the conduit defines a channel that is not in fluid communication with the inner chamber.

13. The method of claim 12, wherein:
the additive manufacturing process includes a plurality of layer deposition steps;
printing the body includes depositing a plurality of body layers;
printing the conduit includes depositing a plurality of conduit layers; and
the method further comprises depositing each of the conduit layers in a same layer deposition step of the additive manufacturing process as a respective one of the plurality of body layers.

14. The method of claim 12, wherein:
the additive manufacturing process includes a plurality of layer deposition steps;
printing the body includes depositing a plurality of body layers;
printing the conduit includes depositing a plurality of conduit layers; and
the method further comprises depositing at least one of the conduit layers in a layer deposition step of the additive manufacturing process that does not include depositing any of the plurality of body layers.

15-16. (canceled)

17. The method of claim 12, further comprising coupling a heat exchanger system to the body of the fuel tank, wherein the conduit forms at least a portion of the heat exchanger system.

18. The method of claim 17, wherein coupling the heat exchanger system to the body includes fluidly coupling the heat exchanger system to the channel, and wherein the conduit is configured to enable heat exchange between fuel stored in the inner chamber and a fluid routed through the channel by the heat exchanger system.

19. The method of claim 17, further comprising routing a heating element through the conduit.

20. The method of claim 12, further comprising printing, during the additive manufacturing process, a reinforcing member monolithic with the body, wherein at least a portion of the reinforcing member forms a baffle within the inner chamber of the body.

21. The method of claim 20, wherein printing the reinforcing member further comprises printing a rib that extends outwards from an outer surface of the body of the fuel tank, wherein the rib is aligned with the baffle.

22-23. (canceled)

24. The method of claim 12, further comprising fluidly coupling the inner chamber of the fuel tank to a fuel line of the aircraft such that the inner chamber of the fuel tank is in fluid communication with the fuel line of the aircraft.

25. An aircraft assembly, comprising:
an aircraft body component including a body coupling portion; and
a fuel tank configured to be disposed within the aircraft body component, the fuel tank having a body including an inner chamber that is configured to hold fuel, wherein the fuel tank includes at least a first fuel tank coupling portion formed monolithically with the body adjacent to an exterior surface of the body, wherein the at least first fuel tank coupling portion of the fuel tank is configured to be slidably received within the body coupling portion of the aircraft body component.

26-32. (canceled)

33. The aircraft assembly of claim 25, wherein the fuel tank further includes a conduit that is monolithic with the body of the fuel tank, extends within the inner chamber of the body and is not fluidly coupled to the inner chamber of the body.

34-39. (canceled)
